(19) United States
(12) Patent Application Publication
(10) Pub. No.: US 2006/0070092 A1
(43) Pub. Date: Mar. 30, 2006

(54) System for handling or recording on encased mediums

(75) Inventor: Wray Russ, Modesto, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Microboards Technology, LLC, Chanhassen, MN (US)

(21) Appl. No.: 11/221,826

(22) Filed: Sep. 9, 2005

Related U.S. Application Data
(60) Provisional application No. 60/613,862, filed on Sep. 27, 2004.

(51) Int. Cl. G11B 17/04

(52) U.S. Cl. 720/619

(57) ABSTRACT

A recording system for encased optical mediums having a housing, a cartridge configured to hold a plurality of mediums, a recording device configured to receive a medium from the cartridge, and a carriage system configured to align the cartridge with the recording device.

### CROSS REFERENCE TO RELATED APPLICATIONS

This application claims priority to U.S. Provisional Patent Application No. 60/613,862, filed Sep. 27, 2004, which is incorporated herein by reference in its entirety.

### FIELD OF THE INVENTION

This invention relates to a recording system for encased mediums and particularly to systems for handling, recording, duplicating or replicating encased optical and magnetic mediums and more particularly optical or magnetic disks.

### BACKGROUND OF THE INVENTION

One of the most popular types of media are optical and magnetic disks. Examples of optical disks include compact disks, digital video disks, and digital versatile disks. The optical disk or CD has recently become a popular form of media for storing digital information, recording high quality audio and video information and for recording computer software of various types. Meanwhile, magnetic disks such as the Iomega® REV™ are also becoming very popular.

With advances in technology, reading information from such optical and magnetic media is now possible, however, it is also possible to record digital information directly onto the media. For example, a recordable compact disk (called a CD-R) can have digital information recorded on them by placing the CD-R into a compact disk recorder that receives the digital information from a computer. Such forms of optical media are thus particularly useful for data distribution and archiving.

The standard compact disk typically does not include a cartridge or encasement for the optical disk. In disks for use with computer processors, they typically adapt the recording formats and content to the particular type of computer processor with which the disk is to operate. Some compact disks are recorded in such a way as to be usable with several different computer processor types, i.e., PC, Macintosh, etc. Disk handling systems typically move a single disk between a stack of disks and a workstation. Such systems are particularly useful for handling memory storage disks such as CD's, DVD's and the like. Common memory storage disk handling systems include data writers, label printers, or both.

The digital compact disk was originally conceived in the early 1980's as a technique to accurately copy and preserve audio recordings intended for sale to a mass market of consumers. As computing power has increased exponentially since then, information processing tasks unthinkable only a few years ago have become commonplace and require large amounts of data most economically and conveniently stored on digital compact disks. Until recently the transfer of data onto compact digital disks was a costly procedure economically feasible only when manufacturing a large quantity of copies. Users whose applications required relatively few copies or required frequent data updates could not reap the benefits of this technology, although low-cost disk-readers were readily available. The advent of recordable digital compact disks, generally referred to as “CD-R” disks, was intended to allow users to record their own disks and thereby achieve significant savings. Unlike a common compact disk that a mold has pressed, a CD-R has a dye layer etched by a laser contained in the CD-R disk drive. Once etched, the “burned” CD-R disk is unalterable and will retain data for approximately 75 years.

Despite their overall durability, compact disks are still prone to damage caused by improper handling. Compact disks, optical disks and magnetic disks are especially susceptible to surface scratches large enough to defeat the disk's internal error correction coding. Disks that are subject to large amounts of physical handling, either manually by humans or automatically by computer systems, are most vulnerable. In order to avoid this problem of the optical disk being damaged, optical and magnetic disks are encased in a cartridge or disk caddy that protects the disk while allowing an input or output device access to the surface of the disk.

Typically, the cartridge or caddy for an optical disk is similar to a floppy disk case including a spring-loaded metallic sleeve that protects a section of the open face of the optical disk. Once inserted into a caddy-compatible disk read/write unit, the metallic sleeve is pushed away and input/output operations can be performed on the optical disk. Magnetic disks typically do not have a spring-loaded metallic sleeve, however, magnetic disks require the same or similar protection that is provided to an optical disk.

The storage capacity of an optical disk depends on the track pitch or size of the data on the disk and the wavelength of the laser used to read the optical disk. The typical wavelength of a red laser used in a DVD or CD is about 640 to about 650 nanometers (nm). A nanometer is one billionth of a meter. Thus, because of the need to increase storage capacity on optical disks, the computer industry is using lasers having different wavelengths.

It is anticipated that the next generation of large capacity optical disk video recording formats will use lasers having wavelengths of less than 500 nm. In a diode laser, as used in optical discs and laser printers, the type of material in the crystal that creates the laser light determines the wavelength and color of the laser light created. For example, the Blu-ray Disc uses a 405 nm blue violet laser that enables the recording, rewriting and play back of up to 27 gigabytes (GB) of data on a single sided single layer 12 cm CD/DVD size disk. In addition, by employing a short wavelength blue violet laser, the Blu-ray Disc can store up to 27 GB of density recording on a single sided disc. A single-sided, double layer Blu-ray Disc has up to 50 GB of density or storage capacity.

In addition, since the new generation disks use global standard “MPEG-2 Transport Stream compression technology, the disc is highly compatible with digital broadcasting for video recording, a wide range of content can be recorded and it is possible for the new generation of disks to record digital high definition broadcasting while maintaining high quality and other data simultaneously with video data if they are received together.

The ability to store increased amounts of data on a disk and the susceptibility of the disk to damage has resulted in optical disks being encased in a cartridge or caddy to protect the optical disc's recording and playback phase from dust and fingerprints. Although, one cannot anticipate the cartridge size, some examples of dimensions of optical and magnetic encased disks include Blu-ray Disc (optical) having a cartridge with dimensions of approximately 129×131×7 mm, and the Iomega® REV™ (magnetic) having a cartridge with dimensions of approximately 75×77×10 mm.

Since optical and magnetic storage disk capacity is expected to grow tremendously over the next few years, it is imperative that disk recording systems be able to handle encased optical and magnetic disks. One desirable use is a system having at least one cartridge for each day of the week, and more particularly a system having 5 (Monday-Friday) or 7 cartridges (Sunday-Saturday).

### SUMMARY OF THE INVENTION

According to one aspect of the present invention, a recording system for encased mediums, the system comprises: a housing; a cartridge configured to hold a plurality of mediums; a recording device configured to receive a medium from the cartridge; and a carriage system configured to align the cartridge with the recording device.

In accordance with another aspect of the present invention, a system for recording data on a medium comprises: a rotary wheel configured to hold a plurality of mediums; a recording device configured to receive a medium from the rotary wheel; and a means for conveying the medium from the rotary wheel to the recording device.

Still other objects, features, and attendant advantages of the present invention will become apparent to those skilled in the art from the reading of the following detailed description of embodiments constructed in accordance therewith, taken in conjunction with the accompanying drawings.

### BRIEF DESCRIPTION OF THE DRAWINGS

FIG. 1 shows a perspective view of a system for handling encased optical mediums.

FIG. 2 shows a side view of the system of FIG. 1.

FIG. 3 shows a perspective view of a cartridge encased medium.

FIG. 4 shows a perspective view of a cartridge configured for use with the system of FIG. 1.

FIG. 5 shows a side view of a cam configured for use with the system of FIG. 1.

FIGS. 6A-6D show a series of side views of the cam removing a medium from cartridge and inserting the medium into the recording device.

FIG. 7 shows a side view of another system for encased mediums.

FIG. 8 shows a top view of the system of FIG. 7.

### DETAILED DESCRIPTION

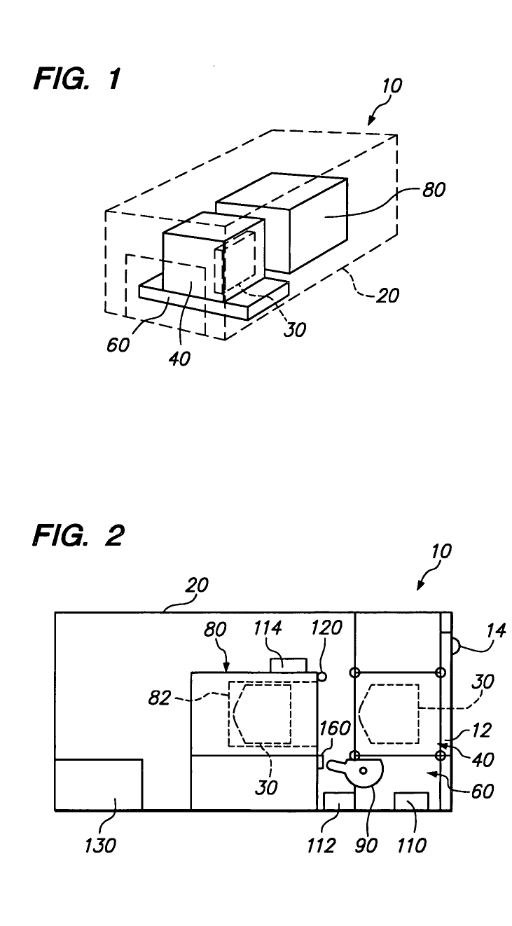

FIG. 1 shows a memory storage system for encased mediums, generally designated with the reference numeral 10. The system 10 includes a housing 20, a cartridge 40, a carriage system 60, and a recording device 80.

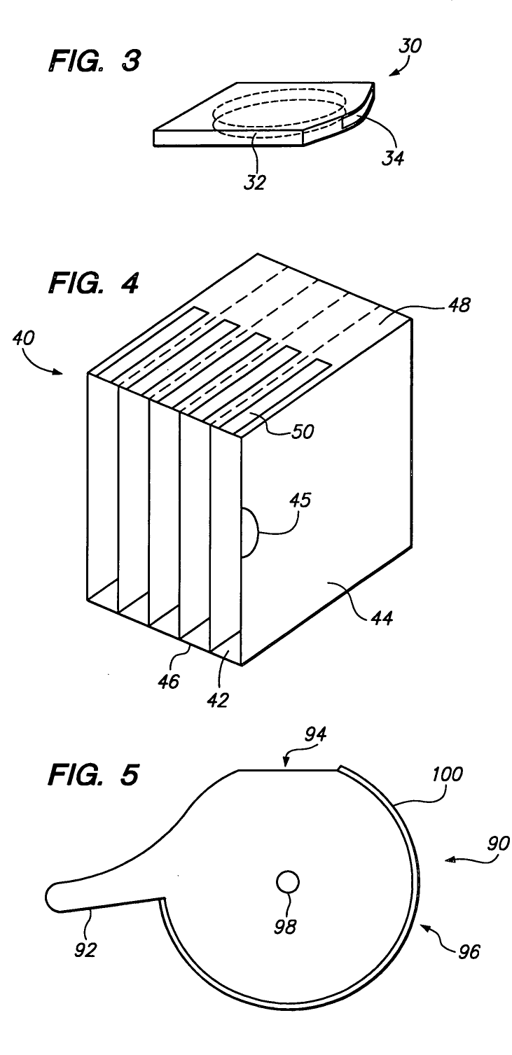

The housing 20 includes at least one cartridge 40 for holding a plurality of recordable mediums 30 (as shown in FIG. 3), such as the Iomega® REV™. The plurality of recordable mediums 30 are preferably encased optical or magnetic disks 32. However, it can be appreciated that the recordable mediums 30 can include Linear Tape-Open technology (LTO), Digital Linear Tape (DLT), and electronic memory cards (including CompactFlash™, SmartMedia™, Memory Stick, PCMCIA Type I and Type II memory cards, memory cards for video game consoles and the like).

The housing 20 protects the cartridge 40, the carriage 60 and the recording device 80 from damage from outside sources. The cartridge 40 (as shown in FIG. 4) holds a plurality of memory storage mediums 30 for delivery to a duplication or recording device 80. The cartridge 40 preferably holds either 5 mediums 30 for a week of five-days (i.e., Monday-Friday) or 7 mediums 30 for an entire week (i.e., Sunday-Saturday). However, it can be appreciated that the cartridge 40 can accommodate between 2 and 100 or more mediums depending on the size of the mediums 30 and the system 10.

FIG. 2 shows a side view of the system 10. As shown in FIG. 2, the system 10 comprises a cartridge 40 configured to hold a plurality of mediums 30. The housing 20 has an opening 22 configured to allow access to the cartridge 40 and carriage system 60. It can be appreciated that the cartridge 40 can be inserted and removed from the housing 20 via the opening 22 in the housing 20, or alternatively, the cartridge 40 can be fixed within the housing 20. In either embodiment, the housing 20 can further include a door 12 with a handle 14, which is configured to allow access to the cartridge 40.

As shown in FIG. 2, the cartridge 40 is positioned on the carriage system 60. The carriage system 60 is configured to align the cartridge 40 with an opening of the recording device 80. The carriage system 60 moves along a track and is controlled by a microprocessor 130. In operation, the carriage system 60 oscillates from a starting position to a plurality of positions for loading and receiving the encased medium 30 from the recording device 80.

A first motor assembly 110 controls the incremental and lateral movement of the carriage system 60. The carriage system 60 is designed to receive a cartridge 40 preferably having between 5 and 7 encased mediums. However, it can be appreciated that the carriage system 60 can be designed to accommodate cartridges 40 having more or less than 5 to 7 encased mediums 30.

The carriage system 60 preferably includes a first motor assembly 110 comprising a drive system and a motor. The drive system can be a belt driven system having a plurality of belts for oscillating the carriage system 60 from loading and receiving the medium 30 from the recording device 80. One skilled in the art will be able to recognize a number of alternative configurations, including rails, rollers and bearings, screw driven or cable driven system is suitable for permitting relative movement of the carriage with respect to the duplication system including a guiding means. The carriage system 60 is preferably driven by a reciprocating means mounted in part within the housing 20. The movement of the carriage system 60 is confined to oscillate within a region defined by a pair of carriage walls.

In one embodiment, the carriage system 60 is mounted or coupled to a screw-driven rotating threaded shaft, not unlike those routinely found in floppy and hard disk drives as well as CD-ROM drives. The screw-driven shaft provides precision positioning of the carriage system 60 by rotating the threaded shafts a predetermined number of revolutions under the control of a suitable drive mechanism.

In another embodiment, the carriage system 60 can include a linkage assembly having a plurality of belts and pulleys. The linkage assembly includes a plurality of pulleys and drive belts to move the carriage system 60. In addition, it can be appreciated that a geared linkage assembly can be substituted in accordance with the present invention for the pulley mechanism, or the cam mechanisms disclosed herein. The motor actuates a mechanical linkage to cause the belt system to move the cartridge 40 laterally from a first position to a second position.

The motor is preferably a servomotor that reciprocates the drive system to precisely move the carriage system 60 in short and precise lateral movement. It can be appreciated that the motor assembly 110 can include and type of motor, however, a servomotor is preferable because of the servomotor's ability to operate in short and uniform movements. The servomotor can be attached to the carriage system 60 through a mechanical linkage assembly. In addition, the servomotor reciprocates the drive system to precisely move the carriage system 60. It can be appreciated that the mechanical linkage assembly can include a plurality of gears, arms or other mechanisms to control the motion of the carriage system 60.

The carriage system 60 also includes a cam 90 configured to remove the encased medium 30 from the cartridge 40. The cam 90 is preferably positioned beneath the cartridge 40 and is configured to assist the system 10 with the removal and insertion of the medium 30 from the cartridge 40 into the recording device 80. The cam 90 preferably rotates both in a counter clockwise and clockwise direction and is configured to allow for both removal of the encased medium 30 from the cartridge 40 and insertion into the recording device 80 and also for receiving the medium 30 from the recording device 80 and insertion of the medium 30 into the cartridge 40.

A second motor assembly 112 controls the rotational movement of the cam 90. The direction of rotation of the cam 90 is a function of the position of cartridge 40 including the medium 30, the carriage system 60 and the direction of acceptance or discharge of the medium 30.

The recording device 80 is preferably a writer configured to write data from another source onto the medium 30 for storage means. Thus, the system 10 is preferably computer hosted. However, it can be appreciated that the system 10 can be a standalone system. The recording device 80 can also include printing, duplicating or replicating capacities for encased optical and magnetic discs or other mediums 30.

As shown in FIG. 2, an optional guide member 120 can be positioned on an upper surface of the recording device 80 to assist with the insertion of the medium 30 into the recording device 80. The guide member 120 preferably comprises a pair of rollers positioned on the upper surface of the recording device 80. The rollers rotate in a clockwise or counter clockwise direction depending on their function and relative position.

A third motor assembly 114 controls the rotational movement of the guide member 120. It can be appreciated the guide member 120 can be rollers or any other suitable device to assist with the insertion of the medium 30 into the recording device 80.

The recording device 80 preferably includes a drive 82 having a means for recording data onto the cartridge encased medium 30. The drive 82 includes read/write heads, a drive motor, a stepper motor, a mechanical frame and a circuit board.

In one embodiment, the read/write heads of the drive 82 can be located on both sides of the medium 30, and move together on the same assembly. The heads are not directly opposite each other in an effort to prevent interaction between the write operations on each side of the two media surfaces. The same head is used for reading and writing, while a second, wider head is used for erasing a track just prior to it being written. This allows the data to be written on a wider clean slate, without interfering with the analog data on an adjacent track.

A very small spindle motor engages the metal hub at the center of the diskette, spinning it at either 300 or 360 rotations per minute. A stepper motor makes a precise number of stepped revolutions to move the read/write head assembly to the proper track position. The read/write head assembly is fastened to the stepper motor shaft. The mechanical frame is a system of levers that opens the little protective window on the diskette to allow the read/write heads to touch the dual sided diskette media. An external button allows the diskette to be ejected, at which point the spring-loaded protective window on the diskette closes. The circuit board contains all of the electronics to handle the data read from or written to the diskette. It also controls the stepper-motor controls circuits used to move the read/write heads to each track, as well as the movement of the read/write heads toward the diskette surface. The recording device 80 can also include recordable drives, medium writers or any other known optical and magnetic medium duplication system.

The system 10 preferably connects to a computer network, or to a stand-alone computer via a standard connection such as a network card and cable, or a serial cable, respectively, so that data, which is to be duplicated, can be communicated to the system 10. It can also be appreciated that the system 10 can independently be designed to function as a standalone recording, duplicating or printing apparatus.

It can be appreciated that the medium recorders are but one example of a workstation type, which can be used in accordance with the present invention. For example, the medium recorders may be replaced with medium printers, medium cleaners, medium surface testing devices and other useful devices in accordance with the present invention.

The system as shown in FIGS. 1-2 is useful in conjunction with recording data on memory storage mediums having an encased or cartridge encased medium or disk. It can be appreciated, however, that a variety of media including optical or magnetic memory storage media may be dispensed and duplicated in accordance with the present invention.

The system 10 also includes a microprocessor 130 in the form of a loader board, a copy board, and/or a hard medium drive to assist the system in dispensing the medium 30 from the cartridge 40 contained on the carriage system 60 and transferring the data to the medium 30. A controller or loader board, including a circuit board within the system 10 regulates operation of the hard medium drive, the copy board and the mechanical linkage for controlling the carriage system 60, the cam 90 and the recording device 80.

In addition, it can be appreciated that the system 10 can be designed with at least one sensor 160 to assist with the operation of the system 10. For example, the at least one sensor 160 can be configured to control the location of the carriage system 60 as the carriage system 60 receives and discharges the medium 30. In one embodiment, the at least one sensor 160 comprises a plurality of sensors 160, and more preferably three (3) sensors, which are configured to sense a home alignment for the cartridge 40, the carriage system 60 and the cam 90. The sensors 160 confirm the positioning of the cartridge 40, carriage system 60, and the cam 90 during operation of the system 10.

Once the data or other media has be written or recorded on the medium 30, the recording device 80 ejects the medium 30 and the carriage system 60 and the cam reverses the process and receives the medium 30 from the recording device 80.

The sensors 160 can be an optical proximity sensor, a micro-switch, a flag sensor, a capacitive sensor, an inductive sensor, a magnetic read switch or any other suitable sensor known to one skilled in the art which recognizes the presence of the carriage system 60 including the medium 30.

In operation, the at least one sensor 160 sends a signal to a microprocessor 130 to begin the process of receiving the medium 30 from the carriage 40 and transferring the medium 30 via the carriage system 60 to one of the recording device 80. Once the recording process has been completed, if appropriate, the microprocessor 130 sends another signal to the carriage system 60 to retrieve the medium 30 and transfer the medium to the recording device 80. In addition, the microprocessor 130 controls the movement of the carriage system 60 such that the mediums 30 are dispensed from the cartridge 40 at the correct intervals.

As shown in FIG. 3, a casing 32 protects the optical disk 34 while allowing an input or output device access to the surface of the optical disk. Specifically, the optical disk casing 32 protects the optical disc's recording and playback phase from dust and fingerprints. The casing 32 can have a spring-loaded metallic sleeve 34 that protects a section of the open face of the disks. Once inserted into the system 10, the metallic sleeve 34 is pushed away and the input/output operations performed by the duplication system 10 can be performed on the optical disk 30. It can be appreciated that other means of accessing the encased optical disk 34 can be utilized without departing from the present invention.

In one embodiment, the medium 30 has a substantially rectangular shape. For example, the Iomega® REV™ has a cartridge with dimensions of approximately 75 mm (length)×77 mm (width)×10 mm (height) mm. Meanwhile, the Blu-ray optical disk comprises an encased optical disk 34 having dimensions of about 129 mm (length)×131 mm (width)×7 mm (height). Since, the dimensions of the casing (or cartridge) can vary according to the diameter and thickness of the optical disk. It can be appreciated that the casing 32 can be rectangular, square, circular or a combination thereof without departing from the present invention.

As shown in FIG. 4, the cartridge 40 comprises a plurality openings 42 configured to receive an encased medium 30. The cartridge 40 comprises a plurality of side plates 44, a top plate 46, and a bottom plate 48. The plurality of side plates 44 divide the cartridge 40 into a plurality of openings 42 configured to receive an encased medium 30. The top plate 46 is preferably a solid plate configured to provide an upper surface to help guide the medium 30 in and out of the cartridge 40. The bottom plate 48 includes a plurality of slots 50 configured to receive a cam 90 (FIG. 5). The cam 90 guides the medium 30 from the cartridge 40 into the recording device 60 and from the recording device 80 into the cartridge 40. The cartridge 40 can be fixed within the housing 20 or alternatively, the cartridge 40 can be designed to be removable from the housing 20. The cartridge 40 preferably has a recess 41 or means for the user to be able to remove the medium 30 from the cartridge 40.

FIG. 5 shows the cam 90, which is configured to assist with the insertion and removal of the mediums 30 from the cartridge 40 and drive 82 of the recording device 80. In operation, the cam 90 engages an outer edge of the medium 30 and horizontally displaces the medium 30 from the cartridge 40.

As shown in FIG. 5, the cam 90 comprises a cam gear having a generally circular shape 96 for approximately 245 to 310 degrees of the 360 degrees of circumference of the cam 90 and more preferably a generally circular shape 96 for approximately 245 to 290 degrees of the 360 degrees of the circumference of the cam 90. The cam 90 also includes a relatively flat portion 94 configured to fit underneath the medium 30 positioned within the cartridge 40. An arm 92 protrudes from the cam 90 and is configured to engage the medium 30. The cam 90 also includes an outer strip 100 to assist with the removal of the medium 30 from the cartridge 40. The outer strip 100 is preferably a rubber-like material, which grips the medium 30 as the cam 90 rotates around a center axis 98.

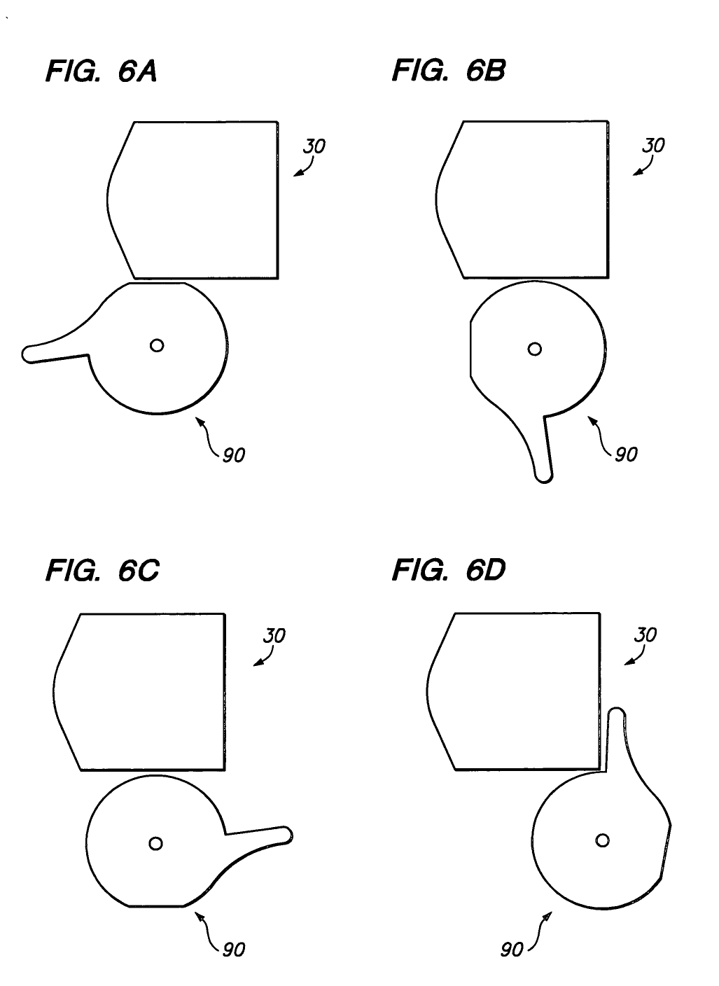

FIGS. 6A-D show a flow diagram of the cam 90 removing the medium 30 from the cartridge 40. As shown in FIG. 6A, the relatively flat portion 94 of the cam 90 is positioned adjacent to an edge of the medium 30 and the slot 50 with the cartridge 40. In this position, the cam 90 does not contact the medium 30 contained within the cartridge 40. Accordingly, the carriage system 60 including the cartridge 40 is free to move laterally.

FIG. 6B shows the cam 90 as it begins to rotate and engages the lower portion of the medium 30. As shown in FIG. 6B, the cam 90 rotates in a clockwise or counterclockwise motion depending on the function it is performing, (i.e. removing the medium 30 from the cartridge 40 or inserting the medium 30 into the cartridge 40 from the recording device 80. As the cam 90 begins to rotate, the outer strip 100 of rubber or suitable material engages the lower portion of the medium 30. The outer strip 100 provides friction or a gripping sensation, which causes the medium 30 to advance from the openings 42 within the cartridge 40.

FIG. 6C shows the cam 90 at a point wherein the cam 90 has rotated approximately 180 degrees. At this time, the medium 30 is advancing forward as a result of the friction between the outer strip 100 and the lower portion of the medium 30. As shown in FIG. 6C, the arm 94 of the cam 90 has rotated approximately 180.

FIG. 6D shows the completion of the removal of the medium 30 from the cartridge 40. As shown in FIG. 6D, the arm 94 of the cam 90 rotates approximately 270 degrees and engages the lower portion of the medium 30. The arm 94 of the cam 90 assists with the removal of the medium 30 from the cartridge 40 and pushes the medium into the drive 82 of the recording device 80.

It can be appreciated that the cam 90 can also assist with the removal of the medium 30 from the recording device 80. In operation, when the recording device 80 has completed recording on the medium 30, whether it be because the medium is full or based on a time, day or week basis, the recording device 80 discards the medium 30 by ejecting the medium 30 from the drive of the recording device 80. The medium 30 is conveyed from the drive of the recording device 80 to the cartridge 40. The arm 94 of the cam 90 rotates in an opposite direction from the insertion of the medium 30 into the drive of the recording device 80 and pushes the medium 30 into the cartridge 40. The process is repeated until each of the mediums 30 within the cartridge 40 has been used.

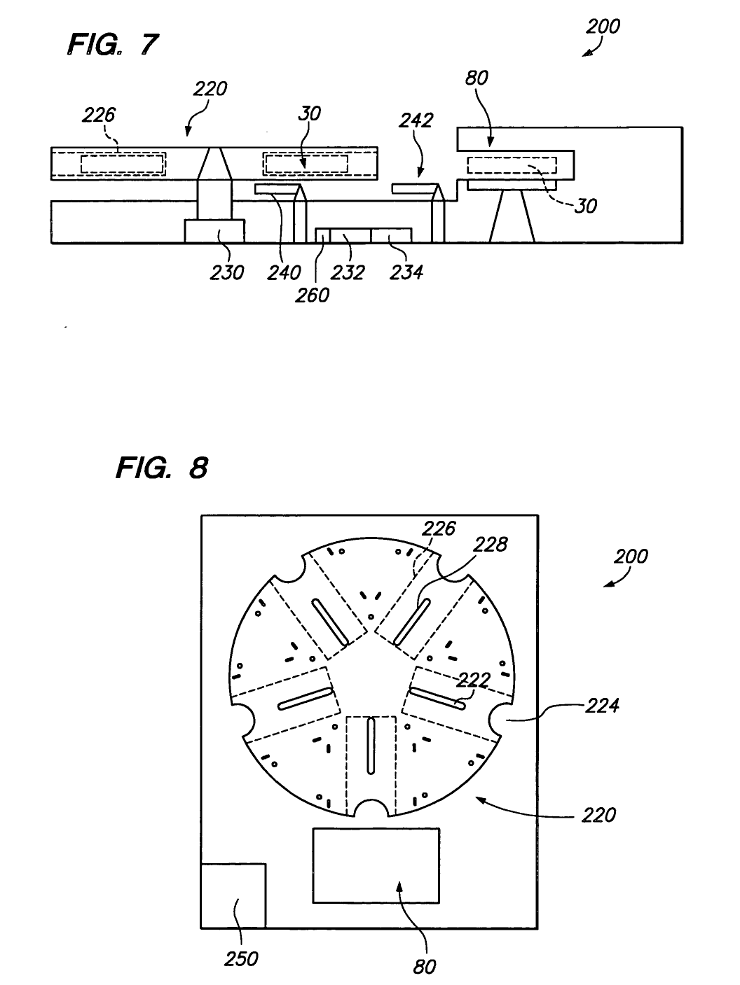

FIG. 7 shows a side view of another embodiment of a system for recording data. As shown in FIG. 7, the system 200 comprises a rotary wheel 220 configured to hold a plurality of mediums 30. The system 200 further comprises a first motor assembly 230 configured to rotate the wheel 220, a recording device 80, and a pair of arms 240, 242 to move the mediums 30 from the rotary wheel 220 to the recording device 80. Each of the rotary wheel arms 240, 242 can be attached to a motor assembly. A microprocessor 250 controls the operation of the rotary wheel 220.

The rotary wheel 220 preferably comprises a lower plate and an upper plate configured to form a plurality of openings 226. The openings 226 are configured to receive a medium 30. The medium 30 can be rectangular, square, circular, oval or any other desirable shape. The plurality of openings 226 preferably number between 2 and 15, and more preferably number between 5 and 7 to accommodate a storage medium 30 for each day of the week, depending if the week is a 5 day work week (Monday through Friday) or a full seven day week (Sunday through Saturday).

A first rotary motor assembly 230 controls the rotation of the rotary wheel 220. The first rotary motor assembly 230 comprises a motor and mechanical linkage assembly including a gear system. Preferably, the motor is a servomotor that reciprocates the gear system to precisely move the rotary wheel 220 in short and precise lateral movement. It can be appreciated that the motor assembly 230 can include any type of motor, however, a servomotor is preferable because of the servomotor's ability to operate in short and uniform movements. The servomotor can be attached to the rotary wheel 230 through a mechanical linkage assembly. In addition, the servomotor reciprocates a gear system to precisely move the rotary wheel 220. It can be appreciated that the mechanical linkage assembly can include a plurality of gears, arms or other mechanisms to control the motion of the rotary wheel 230. It can be appreciated that the rotary wheel 220 can be permanently attached or fixed to first motor assembly 230 or alternatively can be detachable.

A pair of rotary wheel arms 240, 242 extends from below the lower plate through a plurality of slots 228 to slide the medium 30 from the rotary wheel 220 to the recording device 80. Each of the rotary wheel arms 240, 242 further includes a motor assembly 232, 234. The motor assembly controls the movement of the arms 240, 242. The arms 240, 242 move from a first position to a second position, which slides the medium 30 from the rotary wheel 220 to the recording device 80 and from the rotary device 80 to the rotary wheel 220. The arms 240, 242 moves in a 180-degree arc as the mediums 30 move in and out of the recording device 80.

The motor assembly 232, 234 comprises a motor and mechanical linkage assembly including a gear system. Preferably, the motor is a servomotor that reciprocates the gear system to precisely move the rotary wheel arms 240, 242 in short and precise movements. It can be appreciated that the motor assembly 240, 242 can include any type of motor, however, a servomotor is preferable because of the servomotor's ability to operate in short and uniform movements. The servomotor can be attached to the rotary wheel arms 240, 242 through a mechanical linkage assembly. In addition, the servomotor reciprocates a gear system to precisely move the rotary wheel arms 240, 242. It can be appreciated that the mechanical linkage assembly can include a plurality of gears, arms or other mechanisms to control the motion of the rotary wheel arms 240, 242.

FIG. 8 shows a top view of the upper plate of the rotary wheel 220, the recording device 80, and a microprocessor 250. The rotary wheel 220 is preferably circular in nature. However, it can be appreciated that the rotary wheel 220 can also include a plurality of circular cutouts 224 to assist with the insertion and removal of the mediums 30 from the rotary wheel 220.

The microprocessor 250 including a loader board controls the operation of the system 200. Optionally, the system 200 can include at least one sensor 260 to assist with the operation of the system 200.

While the invention has been described in detail with reference to the preferred embodiments thereof, it will be apparent to one skilled in the art that various changes and modifications can be made and equivalents employed, without departing from the present invention.

What is claimed is:

1. A recording system for encased mediums, the system comprising:
a housing;
a cartridge configured to hold a plurality of mediums;
a recording device configured to receive a medium from the cartridge; and
a carriage system configured to align the cartridge with the recording device.

2. The system of claim 1, wherein the recording device has a drive configured to receive the medium from the cartridge.

3. The system of claim 1, further comprising a cam configured to remove the medium from the cartridge.

4. The system of claim 3, wherein the cam has a relatively flat portion.

5. The system of claim 3, wherein the cam has an arm configured to assist with the removal of the medium from the cartridge.

6. The system of claim 1 further comprising at least one motor assembly configured to control the carriage system.

7. The system of claim 3, further comprising at least one motor assembly configured to control the cam.

8. The system of claim 1, further comprising a microprocessor configured to control the operation.

9. The system of claim 1, wherein the carriage system includes at least one pair of rollers for accepting the medium from the carriage and transporting the medium to the duplication system.

10. The system of claim 1, wherein the carriage system includes at least one sensor for aligning the carriage system with the recording device.

11. The system of claim 1, wherein the medium is a magnetic disk.

12. The system of claim 1, wherein the medium is an optical disk.

13. A system for recording data on a medium comprising:
a rotary wheel configured to hold a plurality of mediums;
a recording device configured to receive a medium from the rotary wheel; and
a means for conveying the medium from the rotary wheel to the recording device.

14. The system of claim 13, wherein the means for conveying the medium is at least one arm, wherein the at least one arm slides the medium into the recording device.

15. The system of claim 14, further comprising at least two arms configured to slide the medium into the recording device.

16. The system of claim 15, further comprising a motor assembly configured to rotate the rotary wheel.

17. The system of claim 13, wherein rotary wheel is detachable from the motor assembly.
